(19) United States
(12) Patent Application Publication
(10) Pub. No.: US 2026/0079856 A1
(43) Pub. Date: Mar. 19, 2026

(54) Index Register for Load/Store Unprivileged Instruction

(71) Applicant: Apple Inc., Cupertino, CA (US)

(72) Inventors: Jeff Gonion, Campbell, CA (US); Alexander Donald Charles Chadwick, Cambridge (GB); Bernard J. Semeria, Palo Alto, CA (US)

(21) Appl. No.: 19/324,627

(22) Filed: Sep. 10, 2025

Related U.S. Application Data
(60) Provisional application No. 63/696,128, filed on Sep. 18, 2024.

(51) Int. Cl. G06F 12/14; G06F 9/30

(52) U.S. Cl. CPC G06F 12/1491; G06F 9/30043; G06F 9/3013; G06F 2212/1052

(57) ABSTRACT

A processor circuit may execute a program at a current one of a plurality of privilege levels. The processor circuit may include an LSU circuit and an MMU circuit. The LSU circuit may issue memory access instructions that include load/store unprivileged instructions to be performed based on particular permissions that correspond to an unprivileged level. The MMU circuit may receive, from the LSU circuit, an address associated with a particular load/store unprivileged instruction associated with the program. Code for the particular program may be stored in a particular region of the memory circuit. Based on a determination that the current privilege level is the particular privilege level, the MMU circuit may use particular indices to determine permissions for the particular load/store unprivileged instruction. The particular indices may be specified in one or more registers associated with the particular privilege level.

The present application claims priority to U.S. Provisional App. No. 63/696,128, entitled “Index Register for Load/Store Unprivileged Instruction,” filed Sep. 18, 2024, the disclosure of which is incorporated by reference herein in its entirety.

### BACKGROUND

### Technical Field

This disclosure relates generally to computer processors, and more specifically to the use of load/store unprivileged instructions in a given computer processor.

### Description of the Related Art

Processors, also known as central processing units (CPUs), are the core components of computing devices that perform a wide range of computational tasks. These circuits are responsible for executing instructions within the processor's instruction set architecture (ISA), managing data, and controlling the overall operation of a computer system. Processors are found in various devices, including personal computers, laptops, smartphones, servers, and embedded systems, powering the functionality and performance of these devices.

Some instructions in a processor's ISA may be reserved for execution at a specific privilege level, which is typically determined at the time the instruction is executed. Most software executes at a relatively low level of privilege (e.g., an unprivileged level, sometimes referred to as a “user mode”), preventing the software from accessing and/or updating critical processor state and other protected resources (thus helping ensure security in the system). In many cases, such software cannot execute particular instructions that are restricted to higher levels of privilege. Parts of the operating system that do access/change such state, on the other hand, may execute at more privileged levels (e.g., a privileged privilege level). The number of privilege levels and the instructions that can be executed at each privilege level varies from ISA to ISA.

Permissions play a crucial role in the functioning of processors. A processor's ability to execute tasks efficiently and securely relies on the concept of permissions. Permissions determine what actions and resources are accessible to different components within a system, ensuring the integrity, confidentiality, and availability of data and functionalities. By enforcing permissions, processors ensure that only authorized entities can perform specific operations or access sensitive data, protecting against unauthorized or malicious activities.

Some ISAs may include memory access instructions such as load unprivileged and store unprivileged. Such instructions may be used while a processor is in a privileged level but allow memory accesses to emulate memory context (e.g., memory access permissions) at the unprivileged level. For example, a given processor may execute a program thread in the unprivileged user mode, reading and writing particular memory addresses based on unprivileged permissions. An occurrence of an exception may cause the processor to enter a privileged mode to execute an exception handler to service the exception. While the exception handler is being executed, one or more of the particular memory addresses may be accessed with a desire to read or write these memory addresses as if the processor was in the unprivileged user mode. Use of load/store unprivileged instructions enable such tasks.

### BRIEF DESCRIPTION OF THE DRAWINGS

FIG. 1 illustrates a block diagram of a first embodiment of a system that includes a processor circuit and a memory circuit.

FIG. 2 shows an embodiment of a table indicating which index registers of a processor circuit are used in various privilege levels and modes.

FIG. 3 depicts an embodiment of a chart illustrating index register availability in relation to a current processor privilege level.

FIG. 4 illustrates an embodiment of a permission table for a processor circuit accessed with an index value.

FIG. 5 shows an embodiment of a permission table for a processor circuit accessed with two index values.

FIG. 6 depicts a flow diagram of an embodiment of a method for determining permissions for an instance of a particular load/store unprivileged instruction.

FIG. 7 illustrates a flow diagram of an embodiment of a method for storing an index value in an override register associated with load/store unprivileged instructions.

FIG. 8 shows a flow diagram of an embodiment of a method for determining, based on current privilege level) permissions for an instance of a particular load/store unprivileged instruction.

FIG. 9 is a block diagram of an embodiment of a device.

### DETAILED DESCRIPTION OF EMBODIMENTS

An application executing on a processor may contain code from many disparate origins, including shared libraries, malloc, dynamic linker/loader, application logic, user interface (UI) code. Such code may be allocated to, and loaded into, a particular region of virtual memory space. The code may execute in some instances as separate program threads of the application. For runtime-compiled or just-in-time (JIT) scenarios, code to be executed may come from the input code, the JIT compiler, the JIT validator, or the JIT output region. For a kernel of an operating system, this code may include memory management code, other kernel code, and kernel-mode drivers.

For reasons of security, it is desired to isolate or “sandbox” these disparate components by enforcing certain restrictions on their operation and interaction. For example, it may be desired that only malloc code should be able to read/write malloc metadata; only JIT validator code can write to the JIT output region; shared libraries can only read/write the heap regions of the software component that called them, etc.

A temporal identifier, also referred to herein as an “execution mode identifier,” can also be used as a proxy for identifying what code (i.e., from what memory region) is being executed. Accordingly, the source of a memory access may be qualified with both a spatial identifier (e.g., based on the current value of the program counter (PC) being executed) and a temporal identifier (e.g., the execution mode identifier). Permissions for a given region of virtual memory may thus be based not only on the location of the executing instructions, but also on the identity of a memory region allocated to a software agent.

As a temporal control, the value of the execution mode identifier (which may also be referred to as Tindex, or temporal index) may be changed from time to time as the software agent that is executing changes (e.g., because of a control flow instruction such as a call or return). This change may be effectuated in some implementations via execution of an agent transition instruction within the ISA of a processor circuit. Such instructions may be executed at different privilege levels of a processor circuit that is configured to execute instructions at a plurality of privilege levels. For example, a given software agent may be allocated to a plurality of virtual memory regions, each region having a respective privilege level.

Some applications may have reason to access particular virtual memory regions based on operating contexts (e.g., an execution mode identifier) of a different software agent. For example, an anti-viral program may have reason to access a given memory region allocated to a suspect application. Since the permissions for the given region of virtual memory may be based on the identity of the suspect software agent, the anti-viral program may need to access the memory region using memory access permissions associated with the suspect program. Some ISAs include unprivileged instructions that allow a software agent operating at a privileged level to perform load unprivileged and/or store unprivileged instructions that cause the respective load/store instructions to be performed in the context of a current unprivileged software agent. In some situations, however, it may be desired to perform load/store unprivileged instructions using the context of an unprivileged software agent other than a current unprivileged software agent.

This disclosure describes techniques for implementing additional registers that, when enabled, allow an additional level of modification of load/store unprivileged modes. Such techniques may include, in some embodiments, a load-store unit (LSU) circuit and a memory management unit (MMU) circuit. The LSU circuit may issue memory access instructions that include load/store unprivileged instructions that are to be performed based on a particular set of permissions that correspond to an unprivileged level. The MMU circuit may receive an address associated with a particular load/store unprivileged instruction associated with a particular program allocated to a given region of memory space. Based on a determination that a current privilege level is the particular privileged level, the MMU circuit may use a set of indices to determine permissions for the particular load/store unprivileged instruction., wherein the set of indices is specified in one or more registers associated with the particular privilege level.

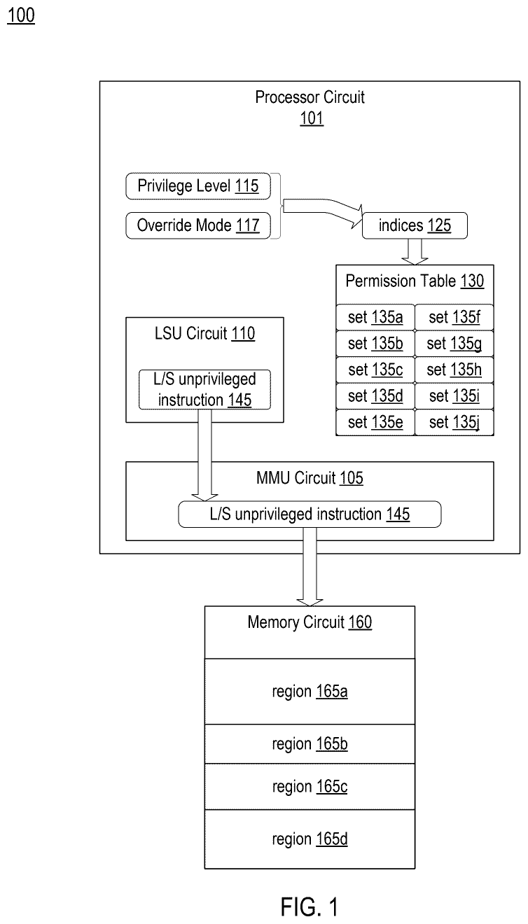

An example computer system is shown in FIG. 1. System 100 of FIG. 1 includes processor circuit 101 and memory circuit 160. Processor circuit 101 includes memory management unit (MMU) circuit 105, load/store unit (LSU) circuit 110, and permission table 130 that further includes a plurality of sets of permissions 135a-135j (collectively 135). Memory circuit 160 includes a plurality of regions 165a-165d (collectively 165). System 100 may be, in whole or in part, a computing system, such as a desktop or laptop computer, a smartphone, a tablet computer, a wearable smart device, or the like. In some embodiments, system 100 is a single IC, such as a system-on-chip, or a multi-die chip.

As illustrated, memory circuit 160 may be implemented using any suitable type of memory including volatile, non-volatile memory, and combinations thereof. Memory circuit 160 may include one or more memory management controllers and may include memory circuits, such as, static random-access memory (SRAM), as well as dynamic random-access memory (DRAM) and/or non-volatile memories such as flash memory. In some embodiments, memory circuit 160 may include interfaces for accessing separate DRAM and/or flash memory devices. As an example, memory circuit 160 may include SRAM, a first memory controller circuit for accessing DRAM, and a second memory controller for accessing flash memory. Program instructions and various types of data files may be stored in the flash data for long-term storage, such as when system 100 is powered-down. During a boot process, an operating system and one or more applications may be launched, including copying at least some of the instructions and related information into DRAM and/or SRAM for faster access by processor circuit 101.

Processor circuit 101, as illustrated, is configured to execute a particular program thread at a particular privilege level of a plurality of privilege levels (e.g., privilege level 115) that include an unprivileged level and a particular privilege level. For example, processor circuit 101 may perform a given program thread associated with a given software agent that is allocated to a given one of regions 165 in memory circuit 160 (e.g., region 165a). Program code for the given software agent in region 165a may be executed at the unprivileged level (e.g., a user mode). At some point in time, a context switch may cause processor circuit 101 to transition to a particular program thread associated with a particular software agent allocated to region 165b, which may be assigned to the particular privilege level. Processor circuit 101 may be further configured to assign respective execution mode identifiers to each of regions 165a and 165b.

As shown, LSU circuit 110 is configured to issue memory access instructions that include load/store (L/S) unprivileged instruction 145 that is to be performed based on a particular one of sets of permissions 135 in permission table 130. In the present example, LSU circuit 110 is configured to issue and execute load/store unprivileged instruction 145 from the particular program thread in region 165b that is executed at privilege level 115. Execution of load/store unprivileged instruction 145 may include sending a memory request to MMU circuit 105.

MMU circuit 105, as illustrated, is configured to receive, from LSU circuit 110, an address associated with load/store unprivileged instruction 145 that is associated with the particular program thread. Based on a determination that privilege level 115 is the particular privilege level and a further determination that override mode 117 corresponds to a first override mode, MMU circuit 105 is further configured to use a first set of indices to determine permissions for load/store unprivileged instruction 145. For example, processor circuit 101 may be configured to determine a current override mode 117 corresponds to a first override mode of a plurality of override modes. These override modes may only be enabled for software agents executing at a more privileged level than the unprivileged level. These override modes may, in combination with an applicable execution mode identifier, further identify how permissions are determined for a given load/store unprivileged instruction. Based on privilege level 115 and override mode 117, processor circuit 101 is configured to determine indices 125 that are accessible by MMU circuit 105. MMU circuit 105, in turn, may be configured to reference a particular set of permissions 135 from permission table 130. The determined set of permissions 135 may include respective indicators for read, write, and execute privileges corresponding to a memory address included in the particular load/store unprivileged instruction.

Indices 125, as depicted, may be associated with a given one of regions 165 in memory circuit 160. Each active software agent may be associated with one or more of regions 165 and, therefore, one or more execution mode identifiers, that are usable to select one of the sets of permissions 135. Ones of the sets of permissions 135 may be further associated with a respective one of the privilege levels. Accordingly, for a given program thread included in a particular one of regions 165, a different one of sets of permissions 135 may be selected based on a current privilege level. In the current example, the first override mode may indicate that indices 125 are selected based on a respective one of regions 165 associated with a current program thread and based on the unprivileged level, despite privilege level 115 corresponding to the particular privilege level. Load/store unprivileged instruction 145, therefore, may cause MMU circuit 105 to access an indicated memory location based on unprivileged access permissions despite being executed at the particular privilege level.

As illustrated, MMU circuit 105 supports a second override mode. Based on a determination that privilege level 115 is the particular privilege level and a determination that this second override mode is active, MMU circuit 105 may be configured to use a second set of indices to determine permissions for load/store unprivileged instruction 145. This second set of indices may be determined by processor circuit 101 based on one or more values in a set of registers within processor circuit 101. Furthermore, these values in the set of registers may not be associated with the current program thread. Accordingly, the second override mode may enable the current program thread to access a particular region in memory circuit 160 using an unprivileged level based on a particular one of regions 165 associated with a different software thread as indicated by the set of registers. Additional details regarding this set of registers is provided below.

Use of such a technique for determining memory access permissions for a load/store unprivileged instruction may increase an ability of privileged program threads to access regions of memory as if the privileged program thread was a different program thread. Such a capability may enable privileged program threads such as an operating system, an exception handler, an anti-virus program, and the like, to have increased capability to monitor and identify and/or fix potential issues associated with other programs active within the processor circuit.

It is noted that system 100, as illustrated in FIG. 1, is merely an example. The illustration of FIG. 1 has been simplified to highlight features relevant to this disclosure. Various embodiments may include different configurations of the circuit elements. For example, processor circuit 101 may include various other elements, such as an execution pipeline, instruction and/or data caches, branch prediction circuits, and the like. In various embodiments, circuits of system 100 may be implemented using any suitable combination of sequential and combinatorial logic circuits. In addition, register and/or memory circuits, such as SRAM, may be used in these circuits to temporarily hold information such as instructions, data, address values, permission table 130, and the like.

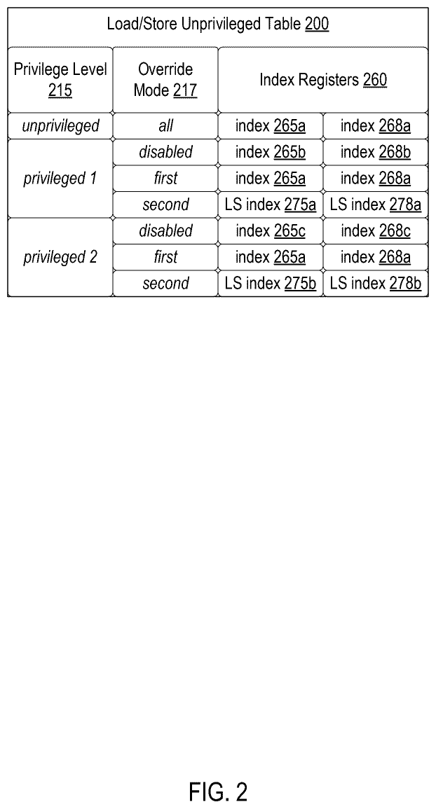

The techniques described in regard to FIG. 1 include use of a set of registers to determine indices for selecting a set of permissions. Such registers may be implemented in a variety of fashions. An example implementation is depicted in FIG. 2.

Moving to FIG. 2, an embodiment of a table depicting a mapping of a plurality of sets of index registers for various privilege levels and override modes. Load/store unprivileged table 200 includes four columns, privilege level 215, override mode 217, and two columns for index registers 260. Load/store unprivileged table 200 includes rows representing three different levels of privilege level 215 and three different states of override mode 217. Index registers 260 identifies particular sets of index registers from which a processor circuit (e.g., processor circuit 101 from FIG. 1) retrieves indices for accessing a permissions table (e.g., permission table 130) in response to issue of a load/store unprivileged instruction.

As illustrated, if privilege level 215 for processor circuit 101 is at the unprivileged level when a load/store unprivileged instruction is issued, then index registers 265a and 268a may be used regardless of override mode 217. Index registers 265a and 268a may be associated with a current active program and may be set, in various embodiments, by hardware circuits in processor circuit 101 and/or a program running at a more privileged level, such as an operating system. The unprivileged level may be a typical user mode at which general user applications are executed. Accordingly, these programs associated with such applications may not be afforded any extra functionality, resulting in load/store unprivileged instructions performing in a same manner as standard load/store instructions. In some embodiments, load/store unprivileged instructions may not be valid for program threads running at the unprivileged level and attempts to execute these instructions at the unprivileged level may result in fulfillment of the load/store unprivileged instruction being aborted and an exception signal being asserted.

If, on the other hand, privilege level 215 is at the privileged 1 level, then override mode 217 may be used to determine one of three different sets of index registers 260 from which to read the indices for accessing permission table 130. If override mode 217 is disabled, then index registers 265b and 268b may be used. Index registers 265b and 268b may identify a current active program at the privileged 1 level. Accordingly, if override mode 217 is disabled, execution of a load/store unprivileged instruction may function in a same manner as a standard load/store instruction. Similar to index registers 265a and 268a, index registers 265b and 268b may be set, in various embodiments, by hardware circuits in processor circuit 101 and/or a program running at a privileged level, including privileged 1 level.

If override mode 217 is a first override mode, then index registers 265a and 268a may be used. As index registers 265a and 268a are indicative of the current thread at the unprivileged level, executing a load/store unprivileged instruction at the privileged 1 level causes the load or store to complete fulfillment as if privileged level 215 is unprivileged, despite being privileged 1.

If override mode 217 is a second override mode, then LS index registers 275a and 278a may be used. LS index registers 275a and 278a may be accessed only at privileged 1 level and may be set to emulate any particular program. LS index registers 275a and 278a may be set by any particular program executing in processor circuit 101 at the privileged 1 level. Programs operating at the unprivileged level do not have access to LS index registers 275a and 278a. Use of the second override mode 217 with load/store unprivileged instructions may allow a privileged program to fulfill memory accesses using permissions associated with any unprivileged program.

When privilege level 215 is at the privileged 2 level, selection of index registers 260 may, like privileged level 1, use override mode 217 to determine one of three different sets of index registers 260 from which to read the indices for accessing permission table 130. If override mode 217 is disabled, then index registers 265c and 268c may be used. Index registers 265c and 268c may identify a current active program at the privileged 2 level. Accordingly, if override mode 217 is disabled, execution of a load/store unprivileged instruction may function in a same manner as a standard load/store instruction. If override mode 217 is the first override mode, then load/store unprivileged instruction is performed as if privileged level 215 is unprivileged, despite being privileged 2. LS index registers 275b and 278b may be used if override mode 217 is the second override mode. Similar to LS index registers 275a and 278a, LS index registers 275b and 278b may be accessed only at privileged 2 level and may also be set to emulate any particular program. Programs operating at the unprivileged and privileged 1 levels may not have access to LS index registers 275b and 278b.

In some embodiments, index registers 265 may correspond to a TIndex value that is representative of a particular region 165 associated with a currently active software agent. Similarly, index registers 268 may correspond to an FPOIndex value that is indicative of a page in memory circuit 160 that is associated with code to be executed, in a certain context. Although load/store unprivileged table 200 depicts use of different index registers 265 and 268 for the different privilege levels, in some embodiments, index registers 265a, 265b, and 265c may correspond to a same register that updates a current value based on the current privilege level. Accordingly, index register 265a may correspond to the TIndex value for a software agent in region 165a executing at the unprivileged level while index register 265b may correspond to an updated TIndex value for a different software agent in region 165b executing at the privileged 1 level. During a context switch between different software agents (or one software agent passing execution from a thread in one of regions 165 to different thread in a different region 165), a current TIndex value in index register 265 may be buffered (e.g., in a stack data structure) before a new TIndex value is stored to index register 265. Accordingly, the prior TIndex value may remain available.

LS index registers 275 and 278 provide a mechanism for setting particular override values for the TIndex and FPOIndex values, respectively. Use of LS index registers 275 and 278 may, therefore, provide a capability to override the default permissions associated with standard load/store instructions, thereby allowing an increased flexibility for programs executing at a more privileged level to emulate operation of different programs executing at different privilege levels, including unprivileged levels.

It is noted that the embodiment of FIG. 2 is one example used for demonstrative purpose. Although three privilege levels and three states of override mode are shown, it is contemplated that any suitable number of privilege levels and override modes may be used. The example of FIG. 2 includes two index registers for each combination of privilege level and override mode. In other embodiments, however, a single index register may be used or more than two index registers may be used.

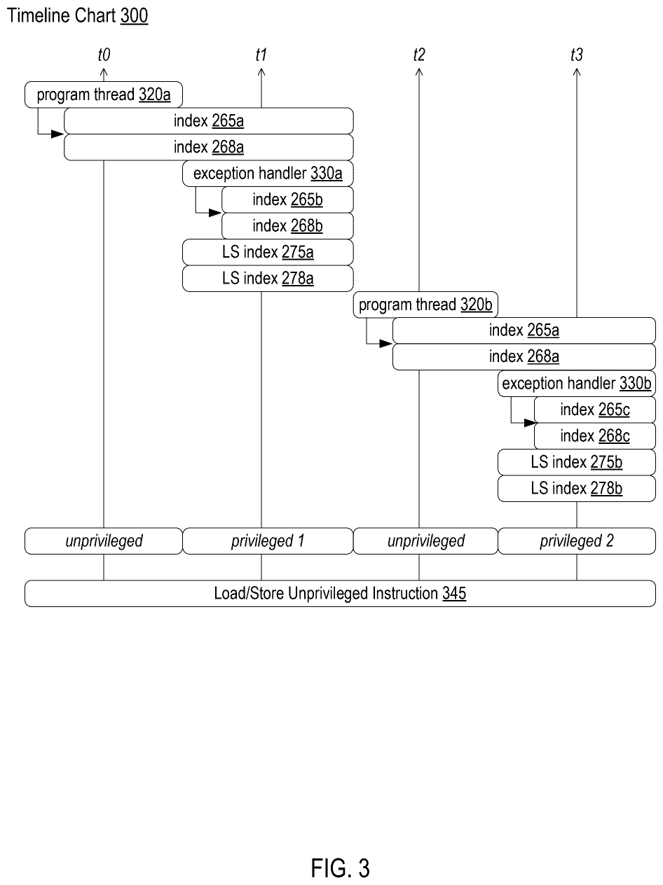

The embodiments disclosed in regard to FIGS. 1 and 2 have described systems in which a current program thread performs a load/store unprivileged instruction in different manners based on a current privilege level and override mode. The privilege level may change for various reasons. FIG. 3 depicts an example of privilege level changes in response to occurrences of exceptions.

Turning to FIG. 3, a timeline chart depicting changes between program threads within a processor circuit that supports load/store unprivileged instruction in different manners based on a current privilege level and override mode associated with the active program thread. Referring to system 100 of FIG. 1 as an example, memory circuit 160 may include a non-transitory, computer-readable medium storing instructions that include one or more instances of a load/store unprivileged instruction 345 that is executable by processor circuit 101 of a computer system to be performed using a particular set of permissions 135 that are retrieved using particular indices 125 that are associated with a particular region 165 that includes the program thread. Execution of a particular instances of load/store unprivileged instruction 345 are indicated by the vertical arrows of timeline chart 300.

As illustrated, prior to and at time t0, processor circuit 101 is performing, at the unprivileged level, instructions associated with program thread 320a which may be associated with region 165a of memory circuit 160. When an instance of load/store unprivileged instruction 345 is issued at time t0, processor circuit 101 determines a current privilege level of processor circuit 101. Based on a determination that the current privilege level is the unprivileged level, processor circuit 101 is capable of accessing index registers 265a and 268a regardless of any override mode. Indices for determining a corresponding set of permissions are retrieved from index registers 265a and 268a and load/store unprivileged instruction 345 is performed in a same manner as a standard load/store instruction. In other embodiments, based on the determination that the current privilege level is the unprivileged level, processor circuit 101 may prevent fulfillment of the particular instance of load/store unprivileged instruction 345.

Prior to time t1, an exception signal is asserted in processor circuit 101, causing program thread 320a to be paused and processor circuit 101 to switch context to exception handler 330a. Exception handler 330a may be associated with region 165b of memory circuit 160 and may include one or more program threads for servicing the cause of the exception signal. In addition, processor circuit 101 is elevated to the privileged 1 level, higher than the unprivileged level. At time t1, a second instance of load/store unprivileged instruction 345 is issued, causing processor circuit 101 to again determine that a current privilege level of processor circuit 101 is the privileged 1 level. Based on this determination, processor circuit 101 may retrieve a set of permissions using indices based on a current override mode. If the current override mode is disabled, then processor circuit 101 may use indices based on values in index registers 265b and 268b, thereby performing the second instance of load/store unprivileged instruction 345 in a same manner as a standard load/store instruction.

If the current override mode is determined to be the first override mode, then processor circuit 101 may retrieve the particular set of permissions using indices that are associated with an unprivileged level, e.g., based on values from index registers 265a and 268a. Processor circuit 101 may then perform the second instance of load/store unprivileged instruction 345 using the same set of permissions as used at time to.

If the current override mode is determined to be the second override mode, then processor circuit 101 may retrieve the particular set of permissions using indices that are associated with an unprivileged level, however, based on values from LS index registers 275a and 278a. As described in regard to FIG. 2, LS index registers 275a and 278a may be set to particular values at any suitable time prior to time t1 by a process thread executing at privileged 1 level. The values of LS index registers 275a and 278a may be set to any suitable value that corresponds to a valid set of permissions. Processor circuit 101 may then perform the second instance of load/store unprivileged instruction 345 using the retrieved set of permissions.

Prior to time t2, exception handler 330a ends, the privilege level of processor circuit 101 is returned to the unprivileged level, and program flow turns to program thread 320b. In various embodiments, program thread 320b may be a part of a same thread as program thread 320a, or may be associated with a different software agent that is also associated with region 165a. Values for index registers 265a and 268a may be updated if program thread 320b is associated with a different one of regions 165. At time t2, a third instance of load/store unprivileged instruction 345 is issued and, since the current privilege level is unprivileged, the third instance of load/store unprivileged instruction 345 is performed in a same manner as the first instance.

Prior to time t3, a different exception signal is asserted in processor circuit 101, causing program thread 320b to be paused and processor circuit 101 to switch context to exception handler 330b. In response to the different exception signal, processor circuit 101 is elevated to the privileged 2 level, higher than both the unprivileged level and the privileged 1 level. At time t3, a fourth instance of third instance of load/store unprivileged instruction 345 is issued. If the current override mode is disabled, then processor circuit 101 determines the set of permissions using values from index registers 265c and 268c that are associated with exception handler 330b. The fourth instance of load/store unprivileged instruction 345 may then be performed using permissions associated with the privileged 2 level.

If the current override mode is, instead, determined to be the first override mode, then processor circuit 101 may retrieve the particular set of permissions using indices that are associated with an unprivileged level, e.g., based on values from index registers 265a and 268a. As described for time t1, processor circuit 101 may perform the fourth instance of load/store unprivileged instruction 345 using the same set of permissions as used at time t2.

On the other hand, if the current override mode is determined to be the second override mode, then processor circuit 101 may retrieve the particular set of permissions using indices that are associated with an unprivileged level, however, based on values from LS index registers 275b and 278b. In a similar manner as described for LS index registers 275a and 278a, LS index registers 275b and 278b may be set to particular values at any suitable time prior to time t3 by a program thread executing at privileged 2 level. LS index registers 275b and 278b may not be accessible when processor circuit 101 is at the unprivileged or privileged 1 levels. Like LS index registers 275a and 278a, the values of LS index registers 275b and 278b may be set to any suitable value corresponding to a valid set of permissions. Processor circuit 101 may then perform the fourth instance of load/store unprivileged instruction 345 using these retrieved set of permissions.

It is noted that that the system of FIG. 3 is merely an example. The illustrated timelines are depicted for clarity and are not intended to imply any particular execution times. As described above, two index registers for each combination of privilege level and override mode are shown. In other embodiments, any suitable number of index registers may be used.

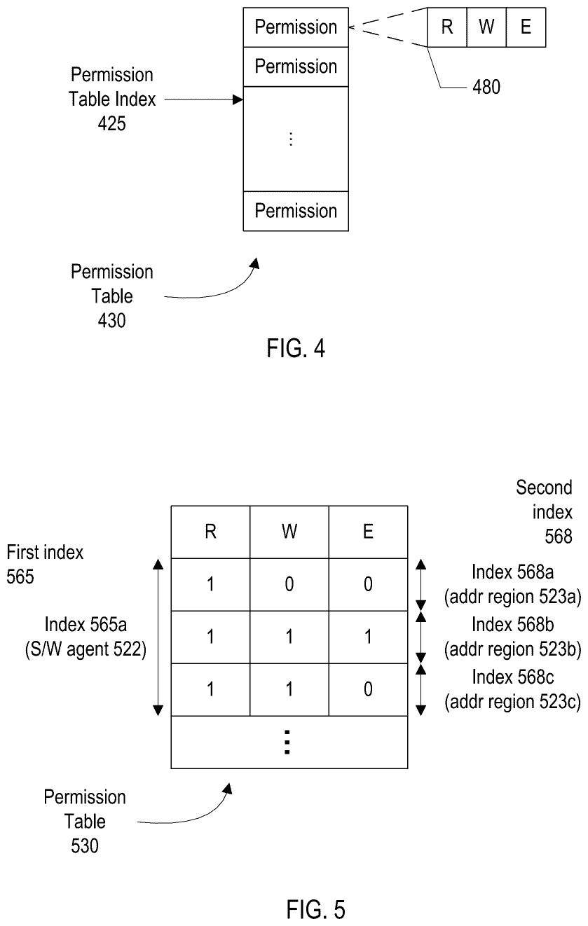

In the discussions of FIGS. 1-3, techniques are disclosed for determining permissions for load/store unprivileged instructions. In FIG. 1, in particular, permission table 130 is depicted as including a plurality of different sets of permissions for performing memory accesses. A permissions table may be implemented in a variety of fashions, two of which are shown in FIGS. 4 and 5.

Proceeding to FIG. 4, an example of one embodiment of a permission table (e.g., permission table 130) is depicted. As shown, permission table 430 includes a plurality of entries indexed by a permission table index 425. In various embodiments, this permission table index 425 may variously be a primary permission table index, a secondary permission table index, or a combined permission table index. An example permission table entry 480 is shown in more detail, including a read permission, a write permission, and an execute permission. These permissions may indicate whether a given memory access request is allowed to, respectively, read a value stored at an address included in the memory access request, write a value to the address, and fetch the value at the address as an instruction to be executed.

As described above, values used to determine permission table index 425 may include a TIndex value indicative of a software agent associated with the memory access request and an FPOIndex value indicative of a target address of the memory access request. The set of permissions included in permission table entry 480 may be valid for a particular range of memory addresses that is indicated by the FPOIndex value. For example, a given entry of permission table 430 may be valid for a particular memory page, memory array, memory circuit, and the like.

FIG. 5 is an example of another embodiment of a permission table, one that allows permissions to be specified according to two “dimensions” or properties. As shown, permission table 530 is configured to store read, write, and execute permissions for virtual address regions. In the particular implementation shown in FIG. 5, a particular set of permissions are accessed using a first index 565 and a second index 568. As described above, indexes 565 and 568 may, in some embodiments, correspond to TIndex and FPOIndex values, respectively. In other implementations, indexes 565 and 568 could be combined into a single index, such as described for FIG. 4. In the example of FIG. 5, two indexes are shown to demonstrate an example of the granularity of the permissions.

The use of two indexes 565 and 568 in the depicted embodiment allows permissions to be specified for two different (and independent) parameters associated with a single instruction. Consider processor circuit 101 executing load/store unprivileged instruction 145 associated with a software agent 522 and accessing data stored in address region 523b. Permissions for such an instruction may be accessed by a first index 565a that selects software agent 522 and a second index 568a that selects address region 523b. As shown, address region 523b has read, write, and execute permissions. Other regions associated with software agent 522, however, can have different permissions: region 523a has read-only permission, while region 523c has read and write permissions, but not execute. The result of using multiple indexes based on different properties/dimensions is that code associated with a given software agent (e.g., a thread or a portion of a thread, specified by first index 565) can have different memory-access permissions for different memory locations (specified by second index 568).

To summarize, various embodiments of a processor circuit are disclosed, wherein the processor circuit may be configured to execute a program at a current one of a plurality of privilege levels. The processor circuit may include an LSU circuit and an MMU circuit. The LSU circuit may be configured to issue memory access instructions that include load/store unprivileged instructions to be performed based on particular permissions that correspond to an unprivileged level. The MMU circuit may be configured to receive, from the LSU circuit, an address associated with a particular load/store unprivileged instruction associated with the program. Code for the particular program may be stored in a particular region of the memory circuit. Based on a determination that the current privilege level is the particular privilege level, the MMU circuit may also be configured to use particular indices to determine permissions for the particular load/store unprivileged instruction. The particular indices may be specified in one or more registers associated with the particular privilege level.

In a further example, the MMU circuit may be further configured to use the set of indices to select, from a table of permissions, particular permissions that are associated with the unprivileged level. In an example, the set of indices may be retrieved from a set of override registers associated with a different program in a different region of the memory.

In another embodiment, the set of indices may be inaccessible in the unprivileged level. In a further example, the MMU circuit may be further configured to, based on a determination that the current privilege level of the particular program is a different privileged level of the plurality of privilege levels and different from the unprivileged level, use a different set of indices to select permissions. The different set of indices may be specified in one or more registers associated with the different privilege level.

In one example, the MMU circuit may be further configured to, based on a determination that the current privilege level of the particular program is the unprivileged level, deny fulfillment of the particular load/store unprivileged instruction. Based on a determination that the current privilege level of the particular program is in the particular privileged level, the MMU circuit may be configured to complete fulfillment of the particular load/store unprivileged instruction based on the determined permissions. In another example, the determined permissions may include respective indicators for read, write, and execute privileges corresponding to a memory address included in the particular load/store unprivileged instruction.

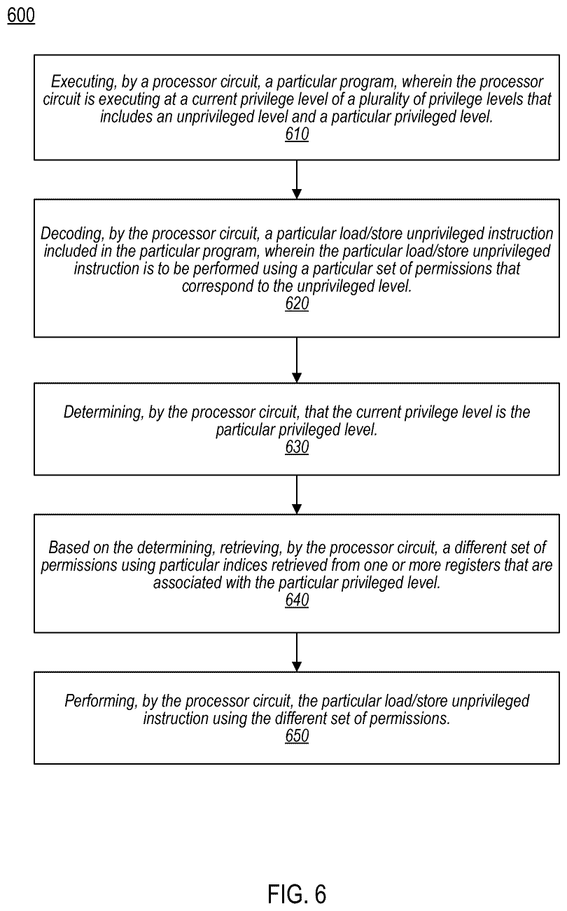

Proceeding to FIG. 6, a flow diagram of one embodiment of a method for determining memory access permissions for a load/store unprivileged instruction. Method 600 is written from the perspective of a processor circuit, such as processor circuit 101 in FIG. 1. Exemplary reference numerals from FIG. 1 are provided for convenience in the following description of method 600. Such reference numerals, however, are not intended to unduly limit the scope of this method.

Method 600 begins at block 610 with a processor circuit executing a particular program thread. The processor circuit may be executing at a current privilege level of a plurality of privilege levels that includes an unprivileged level and a particular privilege level. In addition, the particular program may be held in a particular one of a plurality of regions of a memory circuit. For example, processor circuit 101 may execute a given program thread associated with a first software agent that is associated with a first memory region that is at the unprivileged level. A context switch may occur at a later point in time, causing processor circuit 101 to transition to a second program thread associated with a different software agent in a second memory region that is at the particular privilege level. Respective execution mode identifiers may be assigned to each of the first and second memory regions.

At block 620, method 600 continues by the processor circuit decoding a particular load/store unprivileged instruction included in the particular program thread. A given load/store unprivileged instruction may typically be performed using a particular set of permissions that are retrieved using particular indices that correspond to the unprivileged level. For example, a load/store unprivileged instruction may be used to allow a program associated with a software agent located in a privileged region of memory, such as an operating system and/or an anti-virus program, to emulate an software agent in an unprivileged region of memory when accessing particular memory locations.

Method 600 continues at block 630 by the processor circuit determining that the current privilege level is the particular privilege level. In addition, processor circuit 101, while at the particular privilege level, may determine whether an override mode is enabled. As shown, processor circuit 101 includes at least two override modes as well as an override disabled mode. If the override mode is disabled, then processor circuit 101 may execute the decoded load/store unprivileged instruction in a manner similar to a standard load/store instruction. In the present example, the particular override mode is enabled, causing processor circuit 101 to perform the load/store unprivileged instruction in a different manner than a standard load/store instruction.

At block 640, method 600 proceeds with the processor circuit, based on the determining, retrieving a different set of permissions using particular indices retrieved from one or more registers that are associated with the particular privileged level. For example, in the particular override mode, processor circuit 101 may be configured to retrieve values from one or more registers associated with the particular privilege level and use these values to determine the different indices. The one or more registers differ from index registers that may be used in a typical load/store unprivileged instruction and may be set by previous instructions executed at the particular privilege level. Referring to FIG. 2, the one or more registers may correspond to LS index registers 275a and 278a rather than index registers 265a and 268a that may be used by the typical load/store unprivileged instruction. These indices may then be used by processor circuit 101 to access permission table 130 to retrieve the different set of permissions.

Method 600 continues at block 650 with the processor circuit performing the particular load/store unprivileged instruction using the different set of permissions. By executing the load/store unprivileged instruction in the particular override mode, the set of permissions may be retrieved that provide access to particular locations in memory circuit 160 that would otherwise not be accessible by the particular program thread in a current processor state. A given set of permissions may include, as shown in FIGS. 4 and 5, read, write, and execute privileges corresponding to a respective range of memory addresses. As shown in FIG. 2, the different set of permissions, in particular, grant read, write, and/or execute privileges to the particular load/store unprivileged instruction that may not otherwise be available using index registers 265a and 268a or index registers 265b and 268b.

It is noted that the method of FIG. 6 includes blocks 610-650. Method 600 may end in block 650 or may repeat some or all blocks of the method. For example, method 600 may repeat blocks 620-650 in response to a subsequent instance of the load/store unprivileged instruction. Method 600 may be performed concurrently with a different instance of method 600. In a multicore processor embodiment, for example, respective instances of method 600 may be performed concurrently by different cores.

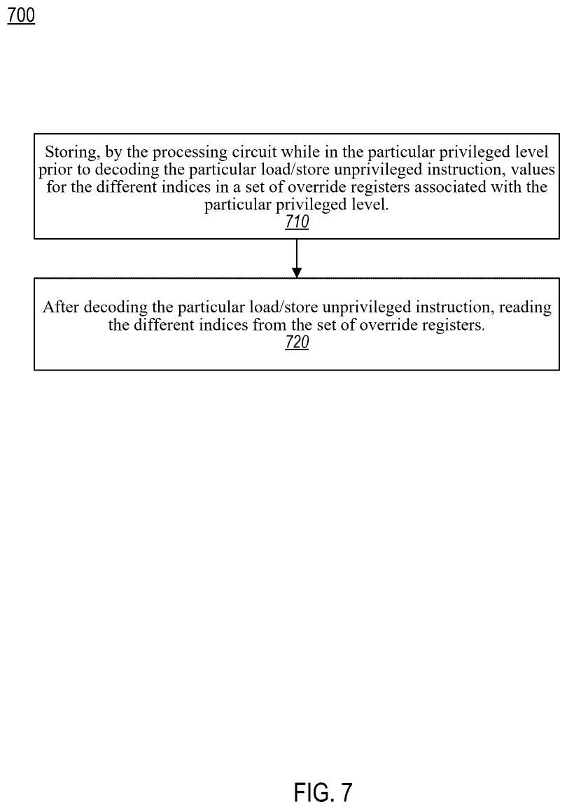

Proceeding to FIG. 7, a flow diagram of an embodiment of a method for setting override registers for a load/store unprivileged instruction is illustrated. In a similar manner as method 600, method 700 may be performed by a processor circuit such as processor circuit 101 in FIG. 1. Method 700 is described below using processor circuit 101 and load/store unprivileged table 200 of FIGS. 1 and 2, respectively. References to elements in FIGS. 1 and 2 are included as non-limiting examples. In some embodiments, method 700 may be performed in conjunction with method 600.

Method 700 may begin at block 710 by a processor circuit storing, while at a particular privilege level prior to decoding a particular load/store unprivileged instruction, values for different indices in a set of override registers associated with the particular privilege level. As described above, LS index registers 275a and 278a may be used to determine indices for retrieving a different set of permissions than would be retrieved using index registers 265a & 268a or index registers 265b & 268b. Processor circuit 101, in some embodiments, may be capable of writing to LS index registers 275a and 278a only at the particular privilege level (e.g., privileged 1 level). Accordingly, a given software agent associated with privileged 1 level (e.g., a particular process in an operating system) may write particular values to LS index registers 275a and 278a prior to the particular load/store unprivileged instruction being decoded.

Method 700 may continue at block 720 by the processor circuit reading, after decoding the particular load/store unprivileged instruction, the different indices from the set of override registers. As described above regarding method 600, decoding the load/store unprivileged instruction while at the privileged 1 level with the particular override mode active may cause processor circuit 101 to read the values stored in block 710 from LS index registers 275a and 278a. These values may then be used to create indices for retrieving the different set of permissions from permission table 130.

It is noted that method 700 includes blocks 710 and 720. Method 700 may end in block 720. If method 700 is performed in conjunction with method 600, then block 640 of method 600 may be performed to determine the different set of permissions.

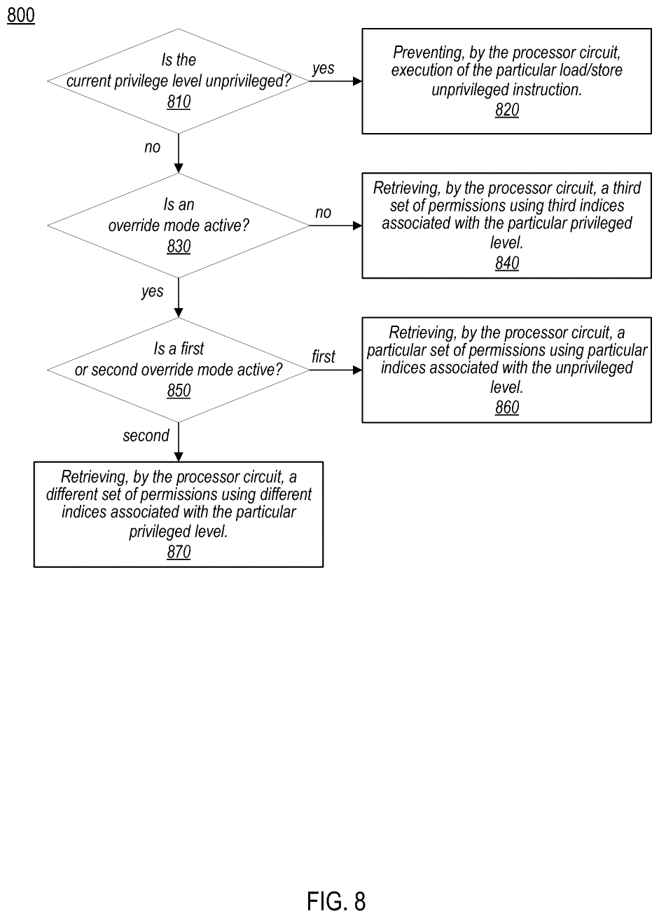

Moving now to FIG. 8, a flow diagram for an embodiment of a method for determining is shown. Similar to methods 600 and 700, method 800 may be performed by processor circuit 101 in FIG. 1. Method 800 is described below using FIGS. 1 and 2 as examples. References to elements in FIGS. 1 and 2 are included as non-limiting examples. In some embodiments, operations of method 800 may be included within blocks 630 and 640 of method 600. Method 800 begins after block 620 of method 600 has been performed.

At block 810, method 800 begins with the processor circuit determining whether the current privilege level is unprivileged. For example, processor circuit 101 may decode an instance of a particular load/store unprivileged instruction. In response to the decoding, processor circuit 101 may determine whether the current privilege level is unprivileged. If so, then method 800 moves to block 820 to prevent execution of the load/store unprivileged instruction. Otherwise, the method moves to block 830 to determine whether an override mode is active.

If the current privileged level is unprivileged, then method 800 continues at block 820 by the processor circuit preventing execution of the particular load/store unprivileged instruction. In some embodiments, if a load/store unprivileged instruction is decoded while processor circuit 101 is at the unprivileged level, then processor circuit 101 may prevent execution of the particular load/store unprivileged instruction. A load/store unprivileged instruction may be considered a privileged level instruction and, therefore, an attempt to execute such a privileged level instruction at an unprivileged level may be indicative of a processing error, a malware attack, and the like. In other embodiments, decoding a load/store unprivileged instruction at the unprivileged level may simply result in the load/store unprivileged instruction being executed in a similar manner as a standard load/store instruction.

If the current privileged level is not unprivileged, then method 800 continues at block 830 with the processor circuit determining whether an override mode is active. In response to determining that processor circuit 101 is currently at a privileged level, processor circuit 101 may then determine whether an override is active. If not, then method 800 moves to block 840 to retrieve a set of permissions associated with the current privileged level. Otherwise, the method moves to block 850 to determine whether a first or second override mode is active.

If an override mode is not active, then method 800 continues at block 840 by the processor circuit retrieving a third set of permissions using third indices associated with the particular privilege level. Referring to load/store unprivileged table 200, for example, if the privileged 1 or privileged 2 level is currently active, then processor circuit 101 retrieves values from associated index registers 265b/268b or 265c/268c, respectively. These values may then be used to determine the third indices for retrieving a set of permissions from permission table 130. Accordingly, executing a load/store unprivileged instruction at a privileged level when no override mode is active may result in the load/store unprivileged instruction being executed in a similar manner as a standard load/store instruction executed at the current privileged level.

If an override mode is active, then method 800 continues at block 850 with the processor circuit determining whether a first or second override mode is active. As described above, processor circuit 101 supports at least two override modes for executing a load/store unprivileged instruction. If a first override mode is active, then method 800 moves to block 860 to perform the load/store unprivileged instruction in a manner consistent with the unprivileged level. Otherwise, method 800 proceeds to block 870 to retrieve different values for determining indices for retrieving permissions.

If the first override mode is active, then method 800 continues at block 860 by the processor circuit retrieving a particular set of permissions using particular indices associated with the unprivileged level. Referring again to load/store unprivileged table 200, if the privileged 1 or privileged 2 level is currently active in the first override mode, then processor circuit 101 retrieves values from associated index registers 265a and 268a, the index registers associated with the unprivileged level. These values may then be used to determine the particular indices for retrieving a set of permissions from permission table 130 corresponding to the unprivileged level. Accordingly, executing a load/store unprivileged instruction at a privileged level when the first override mode is active may result in the load/store unprivileged instruction being executed in a similar manner as a standard load/store instruction executed at the unprivileged level.

If the second override mode is active, then method 800 continues at block 870 by the processor circuit a different set of permissions using different indices associated with the particular privilege level. As shown in load/store unprivileged table 200, if the privileged 1 or privileged 2 level is currently active in the second override mode, then processor circuit 101 retrieves values from associated LS index registers 275a/278a or 275b/278b, respectively. As described above, values for these registers may be written by a program thread executing at the corresponding privileged level prior to decoding the load/store unprivileged instruction. Accordingly, executing a load/store unprivileged instruction at a privileged level when the second override mode is active may result in the load/store unprivileged instruction being executed using any valid set of permissions included in permission table 130.

It is noted that the method of FIG. 8 includes operations 810-870. In a similar manner as described above, performance of various operations of methods 600-800 may be performed concurrently and/or in an interleaved fashion. For example, one or more of methods 600-800 may be performed to determine a given set of permissions for performing a decoded load/store unprivileged instruction.

### Example Device

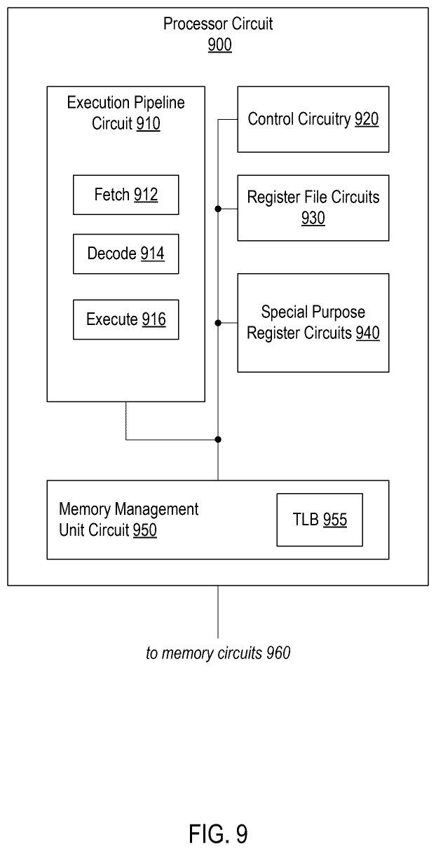

Referring now to FIG. 9, a block diagram of one embodiment of a processor circuit that may be implemented on one or more integrated circuits (ICs) is shown. As depicted, processor circuit 900 includes execution pipeline circuit 910, control circuitry 920, register file circuit 930, special purpose register circuits 940, and memory management unit (MMU) circuit 950. As illustrated, processor circuit 900 is configured to perform instructions included in any suitable instruction set architecture (ISA). For example, processor circuit 900 may be configured to perform instructions included in ARM's ArmV9 ISA, including load/store unprivileged instructions such as load/store unprivileged instruction 145 of FIG. 1. Processor circuit 900 may represent one possible implementation of processor circuit 101 in FIG. 1.

Execution pipeline circuit 910 is representative of circuitry within processor circuit 900 designed to retrieve instructions from memory, and then decode and execute them. Execution pipeline circuit 910 may include any number of stages, but only three exemplary stages are illustrated in FIG. 9. Fetch stage circuit 912, in one embodiment, is configured to issue memory requests to retrieve instructions and operand data via MMU circuit 950. In some embodiments, fetch stage circuit 912 may include pre-fetch circuitry to issue memory requests based on predicted next-fetch addresses. Instructions received via the issued memory requests may be stored in an instruction cache (not pictured) within processor circuit 900. Decode stage circuit 914, in one embodiment, is configured to parse instructions received by fetch stage circuit 912 in order to perform decode operations that prepare the instructions to be processed by execute stage circuit 916. For example, decode stage circuit 914 may be configured to determine from a retrieved instruction: a type of the instruction, a number of its operands, and whether data corresponding to the operands is currently available within processor circuit 900. Decode stage circuit 914 may be configured to place decoded, ready-to-execute instructions in an instruction buffer (not shown) for access by execute stage circuit 916. Execute stage circuit 916, in one embodiment, may retrieve a ready-to-execute instruction from an instruction buffer and perform the instruction using any associated operands. “Performing” the instructions may constitute different actions depending on the type of instruction. Some execution unit circuits within execute stage circuit might be able to complete the instructions, such as in the case of a register operation. Other execution units might initiate execution of an instruction, such as a load/store instruction in which a portion of the memory hierarchy is accessed. Operands of the instruction that reference memory locations may thus be loaded as part of execution by a load/store execution unit circuit and stored in a data cache (not pictured).

In various embodiments, execute stage circuit 916 may perform instructions in a same order as the instructions were fetched (e.g., in-order processing) or may be capable of changing an order of the instructions to improve processor efficiency (e.g., out-of-order processing). Although execute stage circuit 916 is shown as a single block, in some embodiments, execute stage circuit 916 may include a plurality of execution units, such as an integer/Boolean unit, a floating-point unit, a load/store unit, and the like. Execution pipeline circuit 910 may be configured to process one program thread at a time or multiple program threads in an overlapping (e.g., time-sliced) manner.

Control circuitry 920 is configured to perform various processor control operations related to execution of instructions using execution pipeline circuit 910. These control operations include exception handling, context switches, packet transmission, etc. For example, control circuitry 920 may be configured to generate an exception based on a variety of inputs (such as a privileged instruction being decoded at an unprivileged level).

Register file circuits 930 includes a set of registers that may be used to store operands for various instructions of execution pipeline circuit 910. Such registers are commonly called “general purpose registers,” or GPRs. Register file circuits 930 may include registers of various data types, based on the type of operand execution pipeline circuit 910 is configured to store in the registers (e.g., integer, floating point, multimedia, vector, etc.). Register file circuits 930 may directly implement architectural registers or may implement rename circuitry to map architectural registers to physical registers.

Special purpose register circuits 940 are registers within processor circuit 900 that are configured to store specific types of values. These special purpose register circuits 940 stand in contrast to registers of register file circuits 930, which may be used by any instruction executing on processor circuit 900. Thus, index registers 265 and 268, as well as LS index registers 275 and 278 may be implemented as part of special purpose register circuits 940, as they are used for the specific purpose of storing values used to determine memory access permissions. In some embodiments, a particular register in special purpose register circuits 940 may include one or more values for indicating a current privilege as well as one or more values for indicating a status of the override mode. Other examples of special purpose register circuits 940 include the program counter (PC), instruction register (IR), stack pointer (SP), status register (flags register), and various other control registers.

MMU circuit 950 is configured to act as an interface between processor circuit 900 and memory located on memory circuit 960. For example, MMU circuit 950 may issue memory requests to a memory hierarchy that includes memory circuit 960. In one embodiment, MMU circuit 950 is coupled to a memory bus interface to perform read and write operations with memory circuit 960, including retrieving instructions and other information and storing information related to execution of program threads performed by execution pipeline circuit 910.

Furthermore, MMU circuit 950 may receive memory requests from execute stage circuit 916 (e.g., from a load/store unit circuit) and fetch stage circuit 912. In some embodiments, MMU circuit 950 may be coupled to a plurality of execution pipeline circuits, such as may be included in a core complex. Note that additional memory (not pictured) may be located on processor circuit 900. In some embodiments, MMU circuit 950 is configured to receive memory requests that specify virtual addresses. In such embodiments, MMU circuit 950 may be configured to use translation lookaside buffer (TLB) 955 to cache translation information to translate a received virtual address into a physical address corresponding to a particular location in memory circuit 960. Notably, MMU circuit 950 may also be configured to evaluate and enforce permissions related to various instructions in execution pipeline circuit 910, for example, based on a value of one or more of special purpose register circuits 940. In one example implementation, MMU circuit 950 may deny a particular memory request if corresponding permissions are not enabled for a received virtual address specified by a memory-accessing instruction.

Memory circuit 960 may correspond to memory circuit 160 of FIG. 1 and may include one or more memory circuits within a system memory coupled to processor circuit 900. Although illustrated as a single block, memory circuit 960 may include a plurality of memory blocks. Such blocks may include various types of memory including, but not limited to, dynamic random-access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. In some embodiments, memory circuit 960 may include non-volatile memory such as flash memory, ferroelectric random-access memory (FRAM), or magnetoresistive RAM (MRAM). One or more memory devices may be coupled onto a circuit board to form memory modules such as single inline memory modules (SIMMs), dual inline memory modules (DIMMs), etc. Alternatively, the devices may be mounted with an SoC or an integrated circuit in a chip-on-chip configuration, a package-on-package configuration, or a multi-chip module configuration. Memory circuits 960 may also include a non-transitory, computer-readable medium storing instructions that include one or more instances of a load/store unprivileged instruction that is executable by processor circuit 900.

In some embodiments, the elements of processor circuit 900 shown in FIG. 9 may constitute a single processor core. In other embodiments, the depicted elements constitute one of multiple processor cores within processor circuit 900. In still other embodiments, the depicted circuitry may be part of a one or multiple core complexes, with each complex including a plurality of cores sharing support circuitry such as cache and/or branch prediction circuits (not illustrated).

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . W, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a memory circuit configured to hold program code and data for one or more programs in respective regions of the memory circuit;
a processor circuit configured to execute a particular program at a current privilege level of a plurality of privilege levels that include an unprivileged level and a particular privilege level, wherein the processor circuit includes:
a load-store unit (LSU) circuit configured to issue memory access instructions that include load/store unprivileged instructions that are to be performed based on a particular set of permissions that correspond to the unprivileged level; and
a memory management unit (MMU) circuit configured to:
receive, an address associated with a particular load/store unprivileged instruction associated with the particular program, wherein code for the particular program is stored in a particular region of the memory circuit; and
based on a determination that the current privilege level of the particular program is the particular privilege level, use a set of indices to determine permissions for the particular load/store unprivileged instruction, wherein the set of indices is specified in one or more registers associated with the particular privilege level.

2. The apparatus of claim 1, wherein the MMU circuit is further configured to use the set of indices to select particular permissions from a table of permissions that is associated with the unprivileged level.

3. The apparatus of claim 1, wherein the set of indices is retrieved from a set of override registers and are associated with a different program in a different region of the memory circuit.

4. The apparatus of claim 1, wherein the set of indices is inaccessible in the unprivileged level.

5. The apparatus of claim 1, wherein the MMU circuit is further configured to:
based on a determination that the current privilege level of the particular program is a different privilege level of the plurality of privilege levels and different from the unprivileged level, use a different set of indices to select permissions, wherein the different set of indices is specified in one or more registers associated with the different privilege level.

6. The apparatus of claim 1, wherein the MMU circuit is further configured to:
based on a determination that the current privilege level of the particular program is the unprivileged level, deny fulfillment of the particular load/store unprivileged instruction; and
based on a determination that the current privilege level of the particular program is the particular privilege level, complete fulfillment of the particular load/store unprivileged instruction based on the determined permissions.

7. The apparatus of claim 1, wherein the determined permissions include respective indicators for read, write, and execute privileges corresponding to a memory address included in the particular load/store unprivileged instruction.

8. A method, comprising:
executing, by a processor circuit, a particular program, wherein the processor circuit is executing at a current privilege level of a plurality of privilege levels that includes an unprivileged level and a particular privilege level, and wherein the particular program is held in a particular one of a plurality of regions of a memory circuit;
decoding, by the processor circuit, a particular load/store unprivileged instruction included in the particular program, wherein the particular load/store unprivileged instruction is to be performed using a particular set of permissions that correspond to the unprivileged level;
determining, by the processor circuit, that the current privilege level is the particular privilege level;
based on the determining, retrieving, by the processor circuit, a different set of permissions using particular indices retrieved from one or more registers associated with the particular privilege level; and
performing, by the processor circuit, the particular load/store unprivileged instruction using the different set of permissions.

9. The method of claim 8, further comprising:
storing, by the processor circuit while in the particular privilege level prior to decoding the particular load/store unprivileged instruction, values for the particular indices in the one or more registers associated with the particular privilege level; and
after decoding the particular load/store unprivileged instruction, reading the particular indices from the one or more registers.

10. The method of claim 9, further comprising storing, by the processor circuit while in a different privilege level, values for different indices in one or more registers associated with the different privilege level.

11. The method of claim 10, further comprising:
decoding, by the processor circuit, a different instance of the particular load/store unprivileged instruction;
based on determining that the current privilege level is the different privilege level, reading, by the processor circuit, the different indices from the one or more registers associated with the different privilege level; and
retrieving, by the processor circuit, a third set of permissions using the different indices.

12. The method of claim 8, wherein retrieving the different set of permissions using the particular indices includes:
determining, by the processor circuit, a target address for the particular load/store unprivileged instruction; and
retrieving the different set of permissions using the particular indices and the target address.

13. The method of claim 8, further comprising
decoding, by the processor circuit, a different instance of the particular load/store unprivileged instruction;
determining, by the processor circuit, that the current privilege level is the unprivileged level; and
preventing execution of the particular load/store unprivileged instruction.

14. The method of claim 8, wherein performing the particular load/store unprivileged instruction using the different set of permissions includes using, by the processor circuit, the different set of permissions to determine read, write, and execute privileges corresponding to a memory address included in the particular load/store unprivileged instruction.

15. A non-transitory, computer-readable medium storing instructions that include one or more instances of a load/store unprivileged instruction that is executable by a processor circuit of a computer system to be performed using a particular set of permissions that correspond to an unprivileged level, wherein execution of a particular instance of the load/store unprivileged instruction causes the processor circuit to:
determine that a current privilege level of the processor circuit is a particular privilege level different from the unprivileged level;
based on the determination, retrieve a different set of permissions using particular indices that are specified in one or more registers associated with the particular privilege level; and
perform the particular instance of the load/store unprivileged instruction using the different set of permissions.

16. The non-transitory, computer-readable storage medium of claim 15, wherein execution of instructions prior to the particular instance of the load/store unprivileged instruction cause the processor circuit to:
store values for the particular indices in a set of registers associated with the particular privilege level.

17. The non-transitory, computer-readable storage medium of claim 15, wherein execution of a different instance of the load/store unprivileged instruction further causes the processor circuit to:
based on a determination that a current privilege level of the processor circuit is a different privilege level, retrieve a third set of permissions using different indices that are associated with the different privilege level; and
perform the particular instance of the load/store unprivileged instruction using the third set of permissions.

18. The non-transitory, computer-readable storage medium of claim 17, wherein execution of instructions prior to the different instance of the load/store unprivileged instruction cause the processor circuit to:
store values for the different indices in a set of registers associated with the different privilege level.

19. The non-transitory, computer-readable storage medium of claim 15, wherein retrieving the different set of permissions using the particular indices includes:
determining a target address for the particular instance of the load/store unprivileged instruction; and
retrieving the different set of permissions using the particular indices and the target address.

20. The non-transitory, computer-readable storage medium of claim 15, wherein execution of a different instance of the load/store unprivileged instruction further causes the processor circuit to:
based on a determination that the current privilege level is an unprivileged level, prevent execution of the particular instance of the load/store unprivileged instruction.
